(19) United States
(12) Patent Application Publication
(10) Pub. No.: US 2022/0258375 A1
(43) Pub. Date: Aug. 18, 2022

(54) MAGNETIC CHAINSAW CHAIN RETENTION MECHANISM

(71) Applicant: John Wilson, Rancho Santa Fe, CA (US)

(72) Inventor: John Wilson, Rancho Santa Fe, CA (US)

(21) Appl. No.: 17/652,289

(22) Filed: Feb. 24, 2022

Related U.S. Application Data
(60) Provisional application No. 63/149,248, filed on Feb. 13, 2021.
(60) Provisional application No. 63/157,213, filed on Mar. 5, 2021.

(51) Int. Cl. B27B 17/02; B27G 19/00

(52) U.S. Cl. CPC B27B 17/02; B27G 19/003

(57) ABSTRACT

The present invention generally relates to improvements in chainsaws. In particular, the present invention relates to mechanisms for preventing the chain of a chainsaw from falling off the guide bar of the chain saw. According to one embodiment, a magnetic chainsaw chain retention mechanism comprising a magnetic guide bar is provided. The mechanism maintains the chain of a chainsaw on the chainsaw guide bar during use of the chainsaw. As heat expands the overall length of the chain while the chainsaw is running, a magnetic force attracts the chain to the guide bar thus preventing it from falling off. In another embodiment, a magnetic chain is provided, such that the chain remains attracted to the guide bar, wherein, a magnetic force attracts the chain to the guide bar if and when it expands thus preventing it from falling off the guide bar.

### CROSS-REFERENCE TO RELATED APPLICATIONS

This application claims the priority benefit of the provisional application No. 63/149,248 filed on 13 Feb. 2021.

This application also claims the priority benefit of the provisional application No. 63/157,213 filed on 5 Mar. 2021.

All of the above applications are incorporated herein by reference in their entirety.

### FIELD OF INVENTION

The present invention generally relates to improvements in chainsaws. In particular, the present invention relates to magnetic mechanisms for preventing the chain of a chainsaw from falling off the guide bar of the chain saw.

### BACKGROUND OF THE INVENTION

A chainsaw is a power tool that may be used to cut quickly through tree trunks, branches and so on. A chainsaw may be gas or electric. One of the most inconvenient problems with a chainsaw is that during the cutting operation the chain may expand due to the heat generated by the friction between the chain and the chain guide bar. The chain may therefore increase in overall length therein causing a loss of the preset tension of the chain. When this occurs, the chain may fall off from the chain guide bar. This may cause a lot of accidents, and may take a lot time to repair.

The present mechanism will eliminate these inconveniences, making the chainsaw operation safer, the cutting operation much smoother, and may save time by reducing required maintenance of the chainsaw. Further, the present mechanism may not require any additional tools to operate.

A magnetic chainsaw chain tension retention mechanism is provided. The mechanism maintains the chain of a chainsaw on the chainsaw guide bar during use of the chainsaw. As heat expands the overall length of the chain while the chainsaw is running, a magnetic force attracts the chain to the guide bar thus preventing it from falling off.

The magnetic mechanism disclosed herein may be used in connection with many different chainsaw designs and may be used with both gas and electric chainsaws.

Prior patents fail to describe a magnetic chainsaw retention mechanism which is easy to use. Further, these patents fail to provide for a magnetic chainsaw retention mechanism which allow safe and uninterrupted use of a chainsaw.

### SUMMARY OF THE INVENTION

The following summary is an explanation of some of the general inventive steps for the system, method, architecture and tools in the description. This summary is not an extensive overview of the invention and does not intend to limit the scope beyond what is described and claimed as a summary.

The present invention generally relates to improvements in chainsaws. In particular, the present invention relates to mechanisms for preventing the chain of a chainsaw from falling off the guide bar of the chain saw. According to one embodiment, a magnetic chainsaw chain retention mechanism comprising a magnetic guide bar is provided. The mechanism maintains the chain of a chainsaw on the chainsaw guide bar during use of the chainsaw. As heat expands the overall length of the chain while the chainsaw is running, a magnetic force attracts the chain to the guide bar thus preventing it from falling off.

In another embodiment, a magnetic chain is provided, such that the chain remains attracted to the guide bar, wherein, a magnetic force attracts the chain to the guide bar if and when it expands thus preventing it from falling off the guide bar.

According to some embodiments, the present invention utilizes magnetic field forces and can be done in several ways. In some embodiments, is to magnetize the chain saw guide bar. This can be done by using any kind technology of electric magnetizing process that could be an electrical current flowing through a coil to create a magnetic field, which will magnetize the chain bar placed inside it or by using any other kind of existing of metal magnetic technology of magnetizing metals.

In some embodiments, is the use of magnets to create a magnetic field to attract the chains of the chainsaw. The magnets secured to or part of the guide bar or chain attract the chain an guide bar. Therefore, while the chain of the chainsaw can still easily slide parallel and along the perimeter lines of guide bar as a result of the magnetic field created by the magnets of the guide bar.

According to one embodiment, the advantage of this invention is that the present device may be applied to existing chainsaws without needing to modify the existing chainsaw other than merely replacing the current chain with the present magnetic chain.

It is an advantage that the present mechanism will eliminate these inconveniences, making the chainsaw operation safer, the cutting operation much smoother, and may save time by reducing required maintenance of the chainsaw.

Further, the present mechanism may not require any additional tools to operate.

The magnetic mechanism disclosed herein may be used in connection with many different chainsaw designs and may be used with both gas and electric chainsaws.

For a more complete understanding of the above listed features and advantages of the magnetic chainsaw chain retainer mechanism, reference should be made to the detailed description and the drawings. Further, additional features and advantages of the invention are described in, and will be apparent from, the detailed description of the preferred embodiments.

### BRIEF DESCRIPTION OF THE DRAWINGS

The novel features believed to be characteristic of the illustrative embodiments are set forth in the appended claims. The illustrative embodiments, however, as well as a preferred mode of use, further objectives and descriptions thereof, will best be understood by reference to the following detailed description of one or more illustrative embodiments of the present disclosure when read in conjunction with the accompanying drawings, wherein:

FIG. 1 of the drawings illustrates a the construction of a chain operable in a chainsaw.

FIG. 2 of the drawings is a portion of the chainsaw showing a sagging chain, the guide bar and driving sprocket according to one embodiment.

FIG. 3 of the drawings is an illustration of an adjusted chain having its sagging length uniformly distributed along the length of the guide bar.

FIG. 4 of the drawings illustrates a dissection of the construction of the guide bar.

FIG. 5 of the drawings is a portion of the chainsaw showing a sagging chain, the guide bar and driving sprocket according to another embodiment.

FIG. 6 of the drawings is an illustration of a magnetic action to adjust the chain sagging by uniformly distributing the extra length along the length of the guide bar, according to another embodiment.

FIG. 7 of the drawings is an illustration of an adjusted chain having its sagging length uniformly distributed along the length of the guide bar, according to another embodiment.

FIG. 8 of the drawings is a chainsaw.

### DETAILED DESCRIPTION OF THE DRAWINGS

Hereinafter, the preferred embodiment of the present invention will be described in detail with reference to the accompanying drawings. The terminologies or words used in the description and the claims of the present invention should not be interpreted as being limited merely to their common and dictionary meanings. On the contrary, they should be interpreted based on the meanings and concepts of the invention in keeping with the scope of the invention based on the principle that the inventor(s) can appropriately define the terms in order to describe the invention in the best way.

It is to be understood that the form of the invention shown and described herein is to be taken as a preferred embodiment of the present invention, so it does not express the technical spirit and scope of this invention. Accordingly, it should be understood that various changes and modifications may be made to the invention without departing from the spirit and scope thereof.

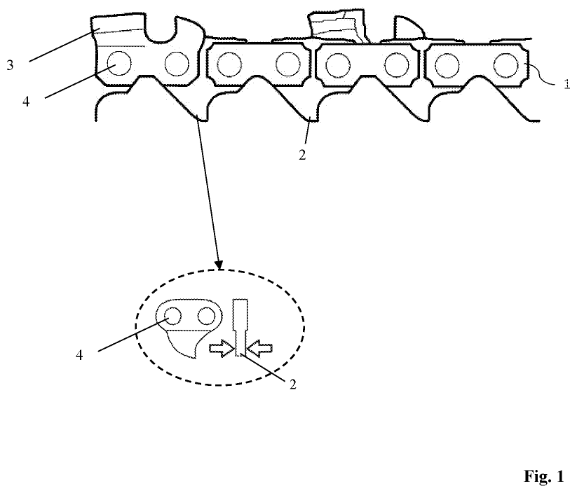

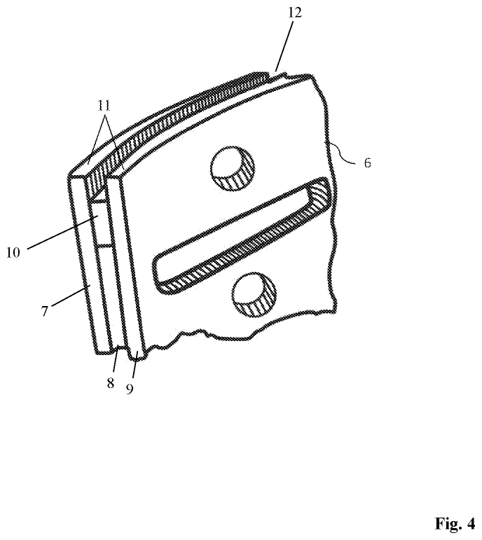

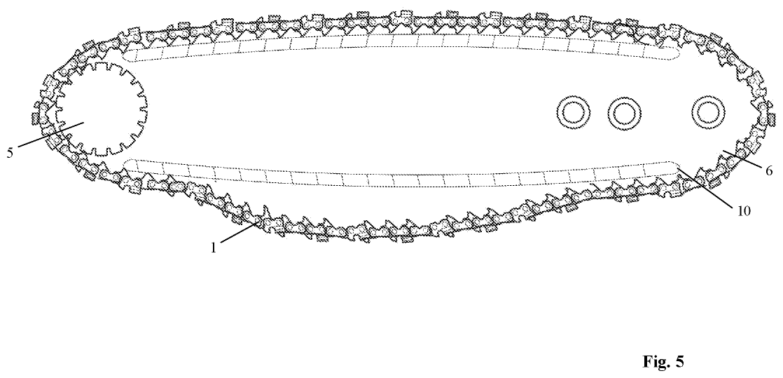

In these descriptions of the preferred embodiments, the FIGS. 1, 2 and 3 refer to an embodiment wherein the chain is made at least in part of magnets, and the guide bar of a magnetic material such as steel, while the FIGS. 4, 5 6, 7 and 8 refer to an embodiment wherein the guide bar is made at least in part of magnets, and the chain of a magnetic material such as steel.

In the embodiment according to FIG. 1 of the drawings illustrates a the construction of a chain operable in a chainsaw. On the figure, it is shown a chain 1 comprising a plurality of chain drive links 2, a plurality of chain teeth 3 and a plurality of chain rivets 4. The plurality of chain drive links 2 enable the chain to be driven by a sprocket around the guide bar to perform a cutting operation. The chain teeth 3 and the chain drive links 2 are joined by the plurality of chain rivets 4 to form a chain. Further illustrated in the same figure are side and frontal views of the chain drive links 2.

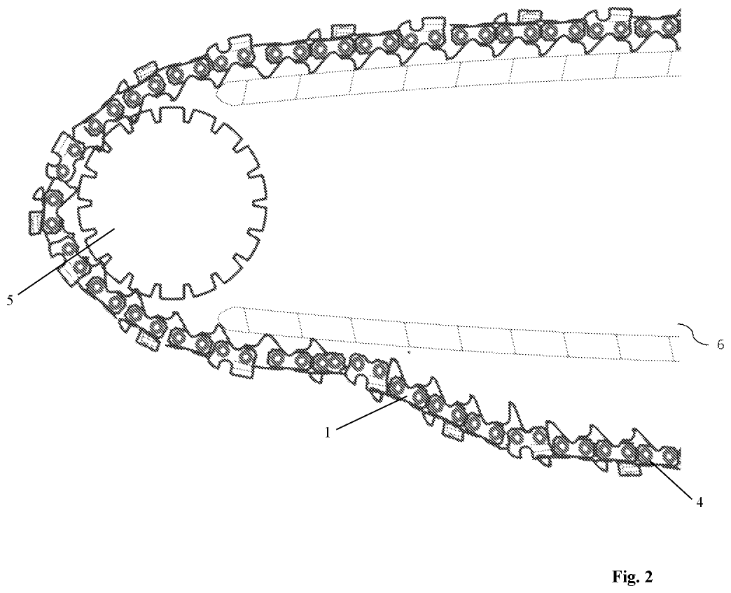

Referring to FIG. 2 of the drawings is a portion of the chainsaw showing a sagging chain 1, the guide bar 6 and driving sprocket 5 according to one embodiment. On the figure, it is shown the chain rivets 4 joining the chain teeth 3 and the chain drive links 2 of the FIG. 1. In a typical chain, the chain rivets 4 are made of metallic material such as steel, iron or any such. However, the chain of the invention may have chain rivets 4 made of magnets and the guide bar 6 being a material that can be attracted by magnets. In another embodiment, the entire chain or portions of it could be made of magnets. The rivets may completely or partially made from extremely strong magnets. For example, the chain links may be made from or with neodymium magnets.

During the operation of a chainsaw, the cutting process generates heat, causing the chain to sag as shown in the figure. However, the disclosed mechanism prevents the chain from falling off the guide bar due to the sagging. During operation of a chainsaw with shown chain rivets 4 made of magnets, the chain is attracted to the guide bar and maintained in place.

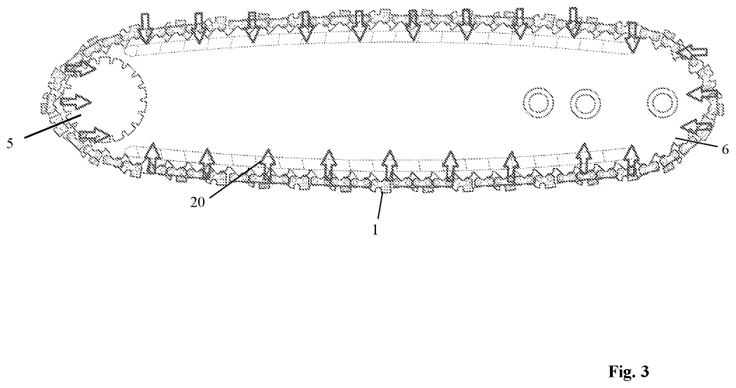

In the embodiment according to FIG. 3 of the drawings is an illustration of an adjusted chain having its sagging length uniformly distributed along the length of the guide bar 6. A driving sprocket 5 is shown on the figure, which may be connected to a power source that rotates it during operation of the chainsaw to drive the chain around the guide bar. During operation of a chainsaw with shown chain rivets 4 made of magnets, a force 20 attracts the chain to the guide bar and maintains it in place. Typical operation causes heat that leads to an expansion of the chain during operation, the extra length is distributed evenly along the guide bar due to the magnetic attraction 20 between the chain and guide bar, preventing the chain from falling off.

In some embodiments, only the rivets are made of magnets.

In some embodiments, the entire chain is made of magnets.

In some embodiments, only portions of the chain is made of magnets.

In some embodiments, an electrical current source adapted to magnetize the chain or portions of it.

Further referring to the embodiment according to the FIG. 4 of the drawings illustrates a dissection of the construction of the guide bar. According to this embodiment, the guide bar comprises of an exterior plate 7, a middle plate 8, and an exterior plate 9. A groove 12 is formed between the exterior plate 7 and exterior plate 9, atop the middle plate 8. Further, the exterior plate 7 and exterior plate 9, define rails 11 along a first and second edge of the guide bar running along at least a portion of the length of the guide bar. In some implementation, magnets 10 are placed in the groove 12 along the entire length of the guide bar, or in strategic portions of it. The groove is adapted to receive a chain along the length of the guide bar, and the chain is being capable of fitting at least partially in the guide bar's groove 12. In some embodiments, the magnets are placed in the guide bar, rather that having a magnetized chain as in FIGS. 1, 2 and 3. In other embodiments, a magnetized chain is arranged in the groove 12 of the guide bar illustrated in FIG. 4.

In the embodiment shown, and as further explained here the chainsaw guide bar is made by two exterior metal sheets plates. Between the two plates is a third metal sheet plate that creates the groove between the exterior two plates which are bound together. The chain of the chainsaw runs along the third (interior) metal plate, between the larger two exterior metal plates. More specifically, the third plate (the interior plate) is smaller in size, forming a groove and therein allows the chain of the chainsaw to rotate around the interior third plate. In one embodiment as shown below, the magnets may located around or are part of the third (interior plate) as shown to keep the chain closes to the third metal plate perimeter and therein within the interior of the groove of the guide bar.

In the embodiment according to FIG. 5 of the drawings is a portion of the chainsaw showing a sagging chain, the guide bar and driving sprocket according to one implementation. For a typical guide bar, the guide bar is made of metallic material such as steel, iron or any such. However, the guide bar of the current invention may have at least some portions 10 made of magnets and the chain 1 being a material that can be attracted by magnets. In another embodiment, the guide bar could be made of magnets.

During the operation of a chainsaw, the cutting process generates heat, causing the chain to sag as shown in the figure. However, the disclosed magnetic mechanism prevents the chain from falling off the guide bar due to the sagging. During operation of a chainsaw with shown of magnets 10 on the guide bar, the chain is attracted to the guide bar by a magnetic attraction 20 and maintained in place.

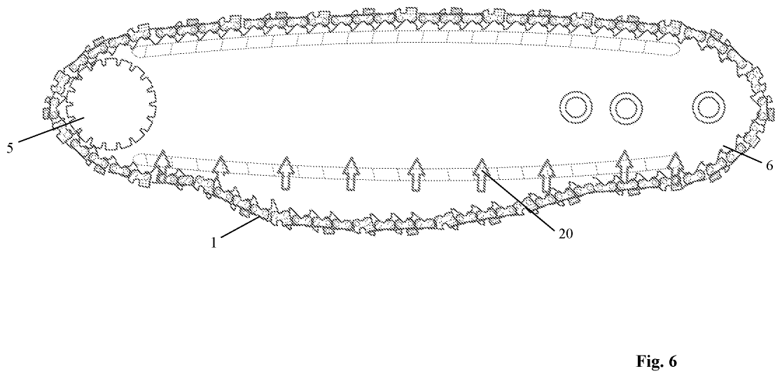

In the embodiment according to FIG. 6 of the drawings is an illustration of a magnetic action to adjust the chain sagging by uniformly distributing the extra length along the length of the guide bar, according to another embodiment. A driving sprocket 5 is shown on the figure, which may be connected to a power source that rotates it during operation of the chainsaw to drive the chain 1 around the guide bar 6. The natural tendency of the chain to sag is countered by a magnetic attraction 20 between the chain and guide bar.

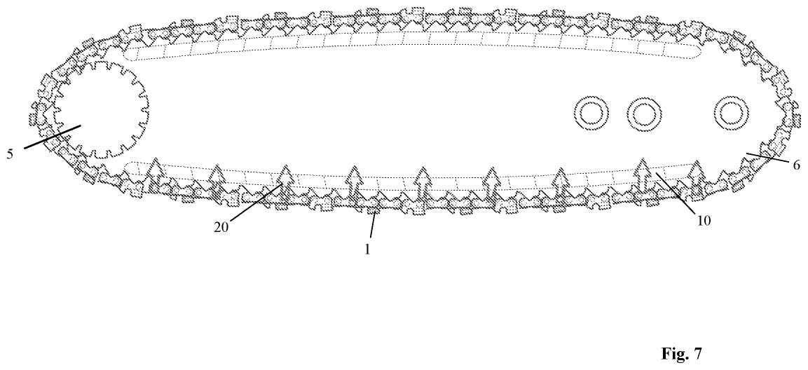

FIG. 7 of the drawings is an illustration of an adjusted chain having its sagging length uniformly distributed along the length of the guide bar, according to another embodiment. During operation of a chainsaw with shown magnetized portions 10, a force 20 attracts the chain to the guide bar and maintains it in place. Typical operation causes heat that leads to an expansion of the chain during operation, the extra length is distributed evenly along the guide bar due to the magnetic attraction 20 between the chain and guide bar, preventing the chain from falling off.

In some embodiments, only portions of the guide bar are made of magnets.

In some embodiments, the entire guide bar is made of magnets.

In some embodiments, an electrical current source adapted to magnetize the guide bar or portions of it.

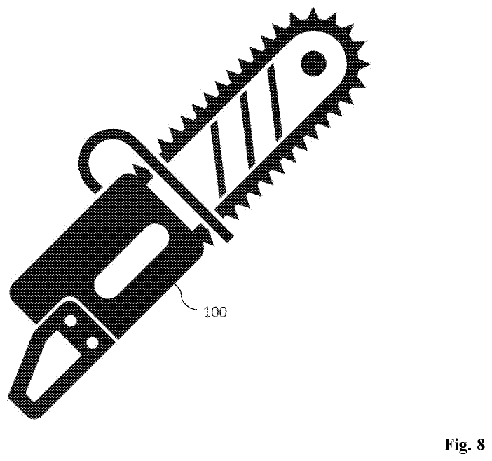

FIG. 8 of the drawings is a chainsaw 100.

Although a preferred embodiment of the present invention has been described for illustrative purposes, those skilled in the art will appreciate that various modifications, additions and substitutions are possible, without departing from the scope and spirit of the invention as disclosed in the accompanying claims. Such alterations are herewith anticipated.

### INDUSTRIAL APPLICATION

The invention is applicable in the chainsaw, and specifically in the manufacture and provision of mechanisms for preventing the chain of chainsaws from falling out of the grooves of the guide bar of the chain saw.

What is claimed is:

1. A chainsaw with a magnetic chain retention mechanism, the chainsaw comprising of:
a guide bar made at least in part of a magnetic material;
a chain operably provided to the guide bar, said chain being made at least in part of magnets, wherein:
during operation, the chain is attracted to the guide bar and maintained in place, and wherein,
in an expansion of the chain during operation, the extra length is distributed evenly along the guide bar due to the magnetic attraction between the chain and guide bar, preventing the chain from falling off.

2. The chainsaw according to claim 1, wherein the guide bar has a rail on its first and second edges on at least a portion of its length, the rails defining a groove along the length of the guide bar, the groove being adapted to receive a chain therein.

3. The chainsaw according to claim 2, wherein the chain is disposed at least partially in said guide bar's groove.

4. The chainsaw according to claim 1, wherein the chain comprises magnetized rivets.

5. The chainsaw according to claim 1, wherein the entire chain is made of magnets.

6. The chainsaw of claim 1, further comprising an electrical current source adapted to magnetize the chain or portions of it.

7. A chainsaw with a magnetic chain retention mechanism, the chainsaw comprising of:
a guide bar made at least in part of a magnet;
a chain operably provided to the guide bar, said chain being made at least in part of a magnetic material, wherein:
during operation, the chain is attracted to the guide bar made at least in part of a magnet and maintained in place; and
in an expansion of the chain during operation, the extra length is distributed evenly along the guide bar due to the magnetic attraction between the chain and guide bar, preventing the chain from falling off.

8. The chainsaw according to claim 1, wherein the guide bar has a rail on its first and second edges on at least a portion of its length, the rails defining a groove along its length, the groove being adapted to receive a chain therein.

9. The chainsaw according to claim 8, wherein the chain is disposed at least partially in said guide bar's groove.

10. The chainsaw according to claim 8, wherein the guide bar comprises of magnets disposed in the groove.

11. The chainsaw according to claim 1, further comprising an electrical current source adapted to magnetize the guide bar or portions of it.

12. A method of providing a magnetic chain retention mechanism in a chainsaw, the method comprising of:
providing a guide bar made at least in part of a magnetic material;
providing a chain operably provided to the guide bar, said chain being made at least in part of magnets, wherein:
during operation, the chain is attracted to the guide bar and maintained in place; and wherein,
in an expansion of the chain during operation, the extra length is distributed evenly along the guide bar due to the magnetic attraction between the chain and guide bar, preventing the chain from falling off.

13. The method of claim 12, further comprising providing rails on a first and second edges on at least a portion of the length of the guide bar, the rails defining a groove adapted to receive a chain therein.

14. The method of claim 13, further comprising arranging the chain at least partially in said guide bar's groove.

15. The method of claim 12, further comprising providing an electrical current source adapted to magnetize the chain or a portion of it.

16. A method of providing a magnetic chain retention mechanism in a chainsaw, the method comprising of:
providing a guide bar made at least in part of a magnet;
providing a chain operably provided on the guide bar, said chain being made at least in part of a magnetic material, wherein:
during operation, the chain is attracted to the guide bar made at least in part of a magnet and maintained in place; and,
in an expansion of the chain during operation, the extra length is distributed evenly along the guide bar due to the magnetic attraction between the chain and guide bar, preventing the chain from falling off.

17. The method of claim 16, further comprising providing rails on a first and second edges on at least a portion of the length of the guide bar, the rails defining a groove adapted to receive a chain therein.

18. The chainsaw of claim 16, further comprising arranging the chain at least partially in said guide bar's groove.

19. The method of claim 16, further comprising providing an electrical current source adapted to magnetize the guide bar or a portion of it.

20. The method of claim 17, further comprising arranging magnets in the groove.
